(19) United States
(12) Patent Application Publication
(10) Pub. No.: US 2003/0126591 A1
(43) Pub. Date: Jul. 3, 2003

(54) Stride-profile guided prefetching for irregular code

(76) Inventors: Youfeng Wu, Palo Alto, CA (US); Mauricio Serrano, San Jose, CA (US)

Correspondence Address: Edwin H. Taylor, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/028,885

(22) Filed: Dec. 21, 2001

(51) Int. Cl. G06F 9/45

(52) U.S. Cl. 717/158; 717/159

(57) ABSTRACT

A compiler technique uses profile feedback to determine stride values for memory references, allowing prefetching of instructions for those loads that can be effectively prefetched. The compiler first identifies a set of loads, and instruments the loads to profile the difference between the successive load addresses in the current iteration and in the previous iteration. The frequency of stride difference is also profiled to allow the compiler to insert prefetching instructions for loads with near-constant strides. The compiler employs code analysis to determine the best prefetching distance, to reduce the profiling cost, and to reduce the prefetching overhead.

### FIELD OF THE INVENTION

The present invention relates to compilers for computers. More particularly, the present invention relates to profile guided optimizing compilers.

### BACKGROUND OF THE INVENTION

Optimizing compilers are software systems for translation of programs from higher level languages into equivalent object or machine language code for execution on a computer. Optimization generally requires elimination of unused generality or finding translations that are computationally efficient and fast. Such optimizations may include improved loop handling, dead code elimination, software pipelining, better register allocation, instruction prefetching, or reduction in communication cost associated with bringing data to the processor from memory. Finding suitable optimizations generally requires multiple compiler passes, and can involve runtime analysis using program tracing or profiling systems that aid in determining execution cost for potential optimization strategies.

Determining suitable optimization strategies for certain types of code can be problematic. For example, irregular code in a program is difficult to prefetch, as the future address of a load is difficult to anticipate. Such irregular code is often found in operations on complex data structures such as “pointer-chasing” code for linked lists, dynamic data structures, or other code having irregular references. Even if pointer chasing code sometimes exhibit regular reference patterns, the changeability of the patterns makes it difficult for traditional compiler techniques to discover worthwhile prefetching optimizations.

At least two major approaches for determining computationally efficient prefetching optimizations have been used. The first approach uses a software based technique known as static prefetching. For example, prefetching instructions for array structures, or software controlled use of rotating registers and predication that incorporate data prefetching to reduce the overhead of the prefetching and branch misprediction penalty are known. Alternatively, in call intensive programs, pointer parameter can be prefetched before the calls. Compiler analysis to detect induction pointers and insert instructions into user programs to compute strides and perform stride prefetching for the induction pointers is also known. However, these instances are generally limited to very specific data structures, or must be employed very conservatively. Even so, static prefetching software techniques can slow a program down when the prefetching is applied to loads that can subtly or abruptly mismatch the required load pattern and the statically determined prefetch pattern.

The second major approach is based on sophisticated hardware prefetching. For example, stream buffer based prefetching uses additional caches with different allocation and replacement policies as compared to the normal caches. A stream buffer is allocated when a load misses both in the data cache and in the stream buffers. The stream buffers attempt to predict the addresses to be prefetched. When free bus cycles become available, the stream buffers prefetch cache blocks. When a load accesses the data cache, it also searches the stream buffer entries in parallel. If the data requested by the load is in the stream buffer, that cache block is transferred to the cache. This approach requires complex hardware and often fails to capture the dynamic load pattern, leading to ineffective hardware utilization.

Another hardware approach that can be used is stride prefetching (where “stride” is defined as the difference between successive load addresses). The hardware stride-prefetching scheme works by inserting a corresponding instruction address I (used as a tag) and data address D1 into a reference prediction table (RPT) the first time a load instruction misses in a cache. At that time, the state is set to ‘no prefetch’. Subsequently, when a new read miss is encountered with the same instruction address I and data address D2, there will be a hit in RPT, if the corresponding record has not been displaced. The stride is calculated as S1=D2−D1 and inserted in RPT, with the state set to ‘prefetch’. The next time the same instruction I is seen with an address D3, a prediction of a reference to D3+S1 is done, while monitoring the current stride S2=D3−D2. If the stride S2 differs from S1, the state downgrades to ‘no prefetch’. Unfortunately, since the prefetching distance is the difference of the data addresses at two misses, it is not a good predictor of stride, often causing cache pollution by unnecessarily prefetching too far ahead or wasted memory traffic by prefetching too late. In addition, the hardware table is limited in size, resulting in table overflow that can cause some of the useful strides to be thrown away.

### BRIEF DESCRIPTION OF THE DRAWINGS

FIG. 1 illustrates a procedures for stride profile guided prefetching of optimizing compiler code; and

FIG. 2 illustrates exemplary code snippets of optimized code derived from an irregular loop of pointer chasing code.

### DETAILED DESCRIPTION OF THE INVENTION

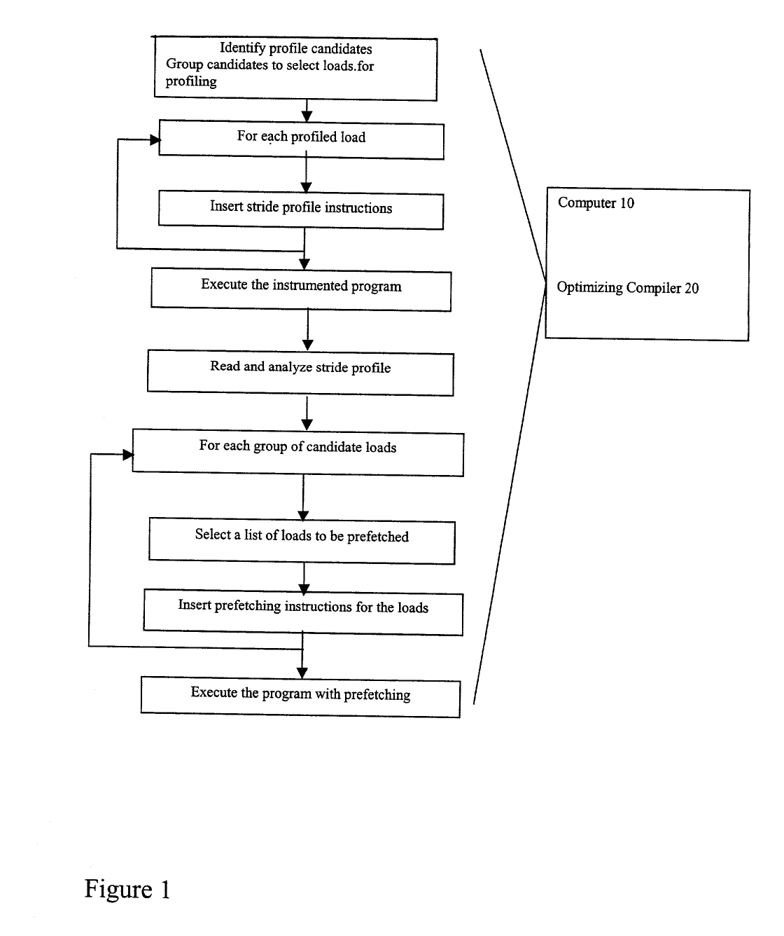

As seen with respect to the block diagram of FIG. 1, the present invention involves a computer system 10 operating to execute optimizing compiler software 20. The compiler software can be stored in optical or magnetic media, and loaded for execution into memory of computer system 10.

In operation, the compiler 10 performs procedures 22 to optimize a high level language for execution on a processor such as the Intel Itanium processor or other high performance processor. As seen in FIG. 1, the optimizing compiler identifies profile candidates, grouping them to select loads for profiling (block 30). The selected loads are called profiled loads. Each profiled load (block 32) has stride profile instructions inserted (block 34), this being repeated as necessary for all profiled loads. The stride profile instructions are executed as part of instrumented program (block 36), providing a stride profile that can be read and analyzed (block 38). For each group of the candidate loads (block 40), the list of loads is selected for prefetching optimization (block 42). Suitable prefetching instructions are inserted for the loads (block 44) and the program is executed with prefetching. Generally, program performance is substantially higher after undergoing such an optimization procedure as compared to the same code which is not optimized by stride profile guided insertion of prefetching instructions.

Identification of load instructions that are suitable stride profile candidates can be based on several criteria. For example, if a load is inside a loop and with a high trip count (e.g. 100 or more), it is likely that prefetching, if possible, could substantially improve program performance. For those loops with a very low trip count, it can be treated as non-loop code and consider the trip count of its parent loop. For example, code having an inner loop that iterates 2 times on the average, while still having an out loop has an average trip count over 10000 can be a suitable stride profile candidate, since stride information is relative to the out loop most of the time, even though the loop has a very low inner loop trip count.

Profile candidate loads (block 32) can include a group of related loads having addresses that differ only by fixed constants. Such groups will have the same stride value or their strides can be derived from the stride for another load. To increase compiler efficiency, only a single member of the group needs to be selected as the representative of the group to be profiled. Examples of related loads are loads that access different fields of the same data structure. If high-level information available, directly analysis is possible if two references access the different fields of the same data structure. Other representative loads are those that access different elements of an array, if the relative distances are known. The relation of loads by analysis of the instructions can be determined in such situations. For example, a base register contains an address may be used with various offsets in different load instructions. In addition, the analysis of related loads can be done at different levels of precision, with high level program analysis finding related loads that access different fields of the same structure, while lower level analysis can find related loads by correlating offsets in different load instructions.

Insertion of profiling instructions (block 34) occurs for each profiled load. Typically, instrumentation includes insertion of a move instruction right after the load operation to save its address in a scratch register; insertion of a subtract instruction before the load to subtract the saved previous address from the current address of the load, placing the difference in a scratch register called “stride”; and insertion of a “profile (stride)” after the subtract instruction but before the load. Other profiling instructions can be used as necessary to provide further information.

The instrumented program is executed (block 36) and the stride profile is collected for reading and analysis (block 38). The inserted function “profile (stride)” collects two types of information for the given series of stride values from a profiled load, referred to as a top stride profile and top differential profile.

The top stride profile involves collection of the top N most frequently occurred stride values and their frequencies. An example for N=2 is follows:

Stride sequence

2, 2,2,2,2,100,100,100, 100

Top[1]=2, freq[1]=5

Top[2]=100, freq[2]=4

Total strides=9

For the nine stride values from a profiled load, the profile routine identifies that the most frequently occurred stride is 2 (Top[1]) with frequency of 5 (freq[1]), and the second mostly occurred stride is 100 with frequency of 4.

The top stride profiling may not give enough information to make a good prefetching decision, so use of a top differential profile is also useful. A top differential profile measures the difference of successive strides to collect the top M most frequently occurred differences. An example for M=2 that assumes the same stride sequence previously given for N=2:

Difference sequence

0, 0, 0, 0, 98, 0, 0, 0

Dtop[1]=0, freq[1]=7

Dtop[2]=98, freq[2]=1

Total differences=8

For the eight differential values for a profiled load, the profile routine identifies that the most frequently occurred difference is 0 (Dtop[1]) with frequency of 7 (Dtop[2]), and the second mostly occurred difference is 98 with frequency of 1.

The differential profile is used to distinguish a phased stride sequence from an alternated stride sequence when they have the same top strides. A comparison of a stride sequence that appears as alternated stride sequence is shown follows:

Stride sequence

2,100,2,100,2,100,2,100,2

Difference sequence

98,−98,98,−98,98,−98,98,−98

As indicated in the following, this sequence has the same top stride profile, but different differential profile:

Top[1]=2, freq[1]=5

Top[2]=100, freq[2]=4

Total strides=9

Dtop[1]=98, freq[1]=4

Dtop[2]=−98, freq[2]=4

Total differences=8

A phased stride sequence is better for prefetching as the stride values in phased stride sequence remain a constant over a longer period, while the strides in an alternated stride sequence frequently change. The phased stride sequence is characterized by the fact that its top differential value is zero, while an alternated stride sequence has none-zero top differential value.

Conventional value-profiling algorithms can be used to collect the top stride values as well as the top differential stride values for each profiled load. The top differential profile is used to tell a phased stride sequence from an alternated stride sequence. In a simple embodiment, the number of zero differences between successive strides can be counted. If this value is high, the stride sequence is presumed to be phased.

Stride prefetching often remains effective when the stride value changes slightly. For example, prefetching at address+24 and the prefetch at address+30 should not have much performance difference, if the cache line is large enough to accommodate the data at both addresses. To consider this effect, the “profile (stride)” routine treat the input strides that are different slightly as the same.

For each group of candidate loads (block 40) a list of loads can be selected for prefetching (block 42) based on stride analysis. The following types of loads can be selected for prefetching:

1) Strong single stride load: Only one stride occurs with a very high probability (e.g. at least 70% of the times).

2) Phased multi-stride load: A few of the stride values together occur majority of the times and the differences between the strides are mostly zeroes. For example, the profile may find out the stride values 32, 60, 1024 together occur more than 60% of times, although none of the stride values occur the majority of the times, and 50% of the stride differences are zero.

3) Weak single stride load: One of the stride values occurs the frequently (e.g. >40% the times) and the stride differences are often zeros. For example, a profile may find out the stride for a load has a value 32 in 45% of times and the stride differences are zeroes 20% of the time.

In the first case, the most likely stride obtained from profile is used to insert prefetching instructions. In the second case, run-time calculation must be used to determine the strides. In the third case, conditional prefetching instructions can be employed.

Insertion of multiple stride prefetching instructions (block 44) may be required for a group of candidate loads, and even though only one member of a group is typically selected for profiling. To decide which ones to prefetch, the range of cache area accessed by the loads in one group is analyzed, providing there is a prefetch for at least one load for each cache line in that range.

Assuming a prefetched load has a load address P in the current loop iteration, and it is a strong single stride load with stride value S, the present invention contemplates insertion of one or more prefetch instructions “prefetch (P+K*S)” right before the load instruction, where K*S is a compile-time constant. The constant K is the prefetch distance and is determined from cache profiling or compiler analysis. If cache profiling shows that the load has a miss latency of W cycles, and the loop body takes about B cycles without taking miss latency of prefetched loads into account, then K=W/B, rounding to the nearest whole number. Cache miss latency estimation is based on the analysis of the working set size of the loop. For example, if the estimated working set size of the loop is larger than the level three cache size, W=level three cache miss latency. If the ratio of W/B is low (e.g. less than one, prefetching the load can be skipped (and the instruction scheduler will be informed to schedule the load with at least W cycle latency).

If no working set size or cache profiling information is available, the loop trig-count can help determine the K value by setting K=min ([trip-count/T], C), where T is the trip count threshold, and C is the max prefetch distance. If this is a phased multi-stride load, the following instructions are inserted:

1) Insert a move instruction right after the load operation to save its new address in a scratch register.

2) Insert a subtract instruction before the load to subtract the saved previous address from the current address of the load. Place the difference in a scratch register called stride.

3) Insert “prefetch (P+K*stride)” before the load, where K should be a power of two so K* stride can be computed easily.

If this is a weak single stride load, the instructions 1 and 2 described in phased multi-stride load are inserted, while step 3 is modified include insertion of a conditional “if (stride==profiled stride) prefetch (P+K*stride)”. The conditional prefetch instruction can be implemented in some architectures using predication. For example, a predicate “p=stride==profiled stride” can be computed and a predicated prefetch instruction “p? prefetch (P+K*stride)” inserted. The conditional instruction necessary is to reduce the number of useless prefetches, when the loop exhibits irregular strides.

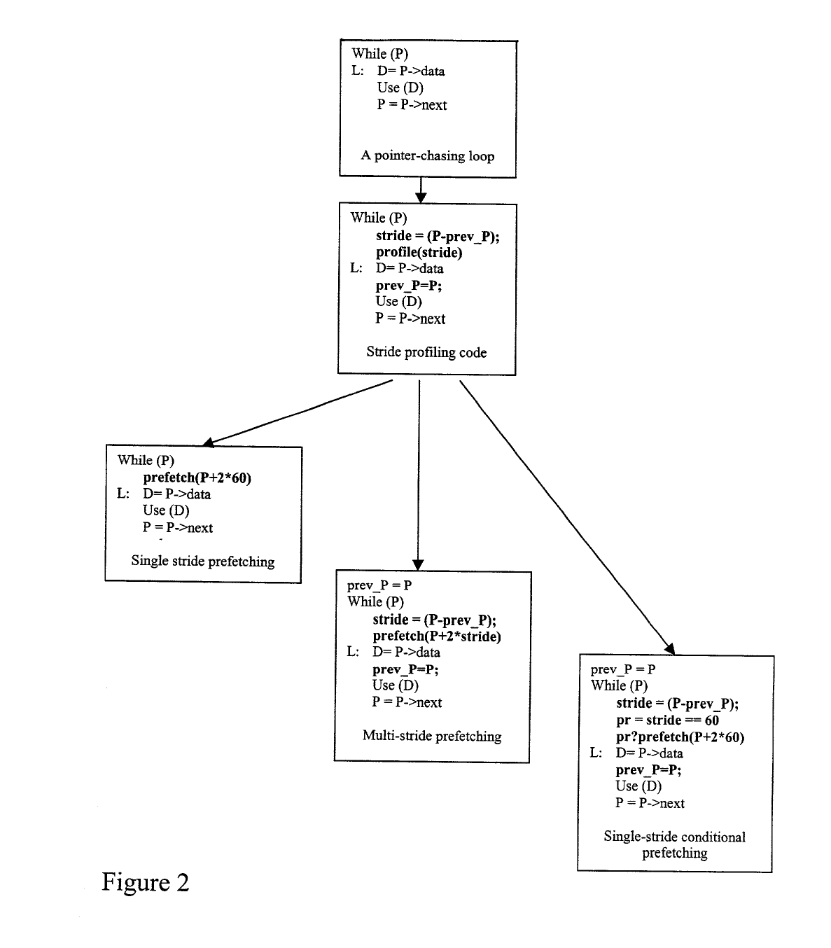

To better appreciate application of the foregoing procedures and methods, consider profile guide optimization procedure 50 of FIG. 2. Using an example of irregular pointer chasing code (block 52) having an instruction L that frequently results in cache misses in an executing program, the code is stride profiled and instrumented (instrument instructions are BOLD in block 54). The variable prev_P stores the load address in the previous iteration. The stride is the difference between the prev_P and current load address P. The stride value is passed to the profile routine to collect stride profile information. Depending on the exact operating parameters, the profile could determine that the load at L frequently has the same stride, e.g. 60 bytes, so prefetching instructions can be inserted as shown in block 60, where the inserted instruction prefetches the load value two strides ahead (2*60). In case the profile indicates that the load has multiple phases with near-constant strides, prefetching instructions may be inserted as shown in block 62 to compute the runtime strides before the prefetching. Furthermore, the stride profile may suggest that a load has a constant stride, e.g. 60, sometime and no stride behavior in the rest of the execution, suggesting insertion of a conditional prefetch as shown in block 64.

Another practical example is supplied with reference to the standard benchmarking code SPEC2000C/C++ 197.parser benchmark which contains the following code segments:

for (; string_list !=NULL; string_list = sn) {

sn = string_list−>next;
use string_list−>string;
other operations;

}

The first load chases a linked list and the second load references the string pointed to by the current list element. The program maintains its own memory allocation. The linked elements and the strings are allocated in the order that is referenced. Consequently, the strides for both loads remain the same 94% of the times with reference input, and would benefit from application of the present invention.

The SPEC2000C/C++ benchmark 254.gap also contains near-constant strides in irregular code. An important loop in the benchmark performs garbage collection, slightly simplified version of the loop is:

while (s < bound) {

| | | |
|---|---|---|
| S2: | if ( (*s & 3 == 0) { | /*71% times are true */ |

| | |
|---|---|
| S2: | access (*s & ˜3)−>ptr |
| S3: | s = s + ( (*s & ˜3)−>size) + values; |
| | other operations; |

| | |
|---|---|
| } else if ( (*s & 3 == 2) { | /* 29% times are true */ |

| | |
|---|---|
| S4: | s = s + constant; |

| | |
|---|---|
| } else { | /* never come here */ |
| } | |

}

The variable s is a handle. The first load at the statement S1 accesses *s and it has four dominant strides, which remain the same for 29%, 28%, 21%, and 5% of the times, respectively. One of the dominant stride occurs because the increment at S4. The other three stride values depend on the values in (*s&˜3)->size added to s at S3. The second load at the statement S2 accesses (*s &˜3L)->ptr. This access has two dominant strides, which remain constant for 48% and 47% of the times, respectively. These multiple near constant rear strides are mostly affected by the values in (*s&˜3)->size and by the allocation of the memory pointed to by *s.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
analyzing a stride profile, and
inserting a prefetch instruction immediately before a load instruction using stride profiling information.

2. The method of claim 1, further comprising the steps of identifying candidate loads, grouping candidate loads and selected profiled loads, inserting profiling instructions, and collecting a stride profile analysis.

3. The method of claim 2, further comprising the step of collecting a top N most frequently occurring stride value and frequency to provide a top stride profile.

4. The method of claim 2, further comprising the step of profiling the difference of successive strides to collect the top M most frequently occurred differences and their frequencies to provide a top differential profile to distinguish phased stride sequences from alternated stride sequences.

5. The method of claim 1, further comprising the step of analyzing range of cache area accessed by a load in a loop, and inserting a prefetch instruction at the additive combination of a load address P and a determined compile time constant.

6. The method of claim 5, further comprising the step of determining a prefetching distance from at least one of a cache profile and a compiler analysis.

7. The method of claim 1, further comprising determining a cache profile to assist in determining appropriate insertion of a prefetch instruction.

8. An article comprising a computer-readable medium which stores computer-executable instructions, the instructions causing a computer to:
analyze a stride profile for code;
insert a prefetch instruction immediately before a load instruction using stride profiling information.

9. The article comprising a computer-readable medium which stores computer-executable instructions of claim 8, wherein the instructions further cause a computer to identify candidate loads, group candidate loads and selected profiled loads, insert profiling instructions, and collect a stride profile analysis.

10. The article comprising a computer-readable medium which stores computer-executable instructions of claim 9, wherein the instructions further cause a computer to collect a top N most frequently occurring stride value and frequency to provide a top stride profile.

11. The article comprising a computer-readable medium which stores computer-executable instructions of claim 8, wherein the instructions further cause a computer to profile the difference of successive strides to collect the top M most frequently occurred differences and their frequencies to provide a top differential profile to distinguish phased stride sequences from alternated stride sequences.

12. The article comprising a computer-readable medium which stores computer-executable instructions of claim 9, wherein the instructions further cause analyzing range of cache area accessed by a load in a loop iteration, and insertion of a prefetch instruction at the additive combination of a load address P and a determined compile time constant.

13. The article comprising a computer-readable medium which stores computer-executable instructions of claim 9, wherein the instructions further cause determination of a prefetching distance from at least one of a cache profile and a compiler analysis.

14. The article comprising a computer-readable medium which stores computer-executable instructions of claim 9, wherein the instructions further cause determination of a cache profile to assist in determining appropriate insertion of a prefetch instruction.

15. A system for optimizing software comprising:
an analyzing module for determining a stride profile; and
an optimizing module for inserting a prefetch instruction immediately before a load instruction using stride profile.

16. The system of claim 15 for optimizing software further comprising:
a stride profiling module that identifies candidate loads, groups candidate loads and selected profiled loads, inserts profiling instructions, and executes and instrumented program.

17. The system of claim 16 for optimizing software wherein the stride profiling module collects a top N most frequently occurring stride value and frequency to provide a top stride profile.

18. The system of claim 16 for optimizing software wherein the stride profiling module profiles the difference of successive strides to collect the top M most frequently occurred differences and their frequencies to provide a top differential profile to distinguish phased stride sequences from alternated stride sequences.

19. The system of claim 15 for optimizing software wherein the optimizing module analyzes a range of cache area accessed by a load in a loop iteration, and inserts a prefetch instruction at the additive combination of a load address P and a determined compile time constant.

20. The system of claim 19 for optimizing software wherein the optimizing module determines a prefetching distance from at least one of a cache profile and a compiler analysis.

21. The system of claim 19 for optimizing software wherein the analyzing module determines a cache profile to provide information to the optimizing module.
